(19) United States
(12) Patent Application Publication
(10) Pub. No.: US 2026/0129515 A1
(43) Pub. Date: May 7, 2026

(54) Multi-Link Sensing Assisted Wi-Fi offload enablement

(71) Applicant: Charter Communications, Stamford, CT (US)

(72) Inventors: Inmaculada Carrion Rodrigo, Valley Center, CA (US); Mohit Anand, Centennial, CO (US)

(73) Assignee: Charter Communications, Stamford, CT (US)

(21) Appl. No.: 18/759,342

(22) Filed: Jun. 28, 2024

(51) Int. Cl. H04W 28/086; H04W 24/08; H04W 84/12

(52) U.S. Cl. CPC H04W 28/0865; H04W 24/08; H04W 84/12

(57) ABSTRACT

The present disclosure relates to a method for controlling a user equipment (UE) utilizing multi-link sensing (MLS) to offload data sessions from a 3GPP network to a non-3GPP network via a WLAN when WLAN functionality is initially disabled at the UE. The method involves receiving an MLS data associated with a radio frequency (RF) environment and/or a physical environment, processing the received MLS data to determine an environmental signature, comparing the determined environmental signature against stored environmental signatures, and enabling the WLAN functionality at the UE based on the comparison to facilitate the offload of data sessions from the 3GPP network to the non-3GPP via the WLAN.

### FIELD OF THE INVENTION

The present disclosure generally relates to wireless communication networks, and more specifically, to systems and methods for offloading data sessions from 3GPP networks to non-3GPP networks using multi-link sensing technology.

### BACKGROUND

Wireless Local Area Networks (WLANs) are a type of wireless network that allows devices to connect and communicate without the use of physical wired connections. One common example of a WLAN is based on the IEEE 802.11 standard, often called Wi-Fi. WLAN networks are commonly used in homes, offices, and public spaces to provide wireless internet access for user devices such as laptops, smartphones, and tablets. WLANs connect to an access network, such as a non-3GPP access network, and provide a wireless connection for user devices to non-3GPP access networks, which together provide internet access. Non-3GPP networks refer to networks that are not based on 3GPP standards. These can include various types of wired and wireless networks, such as Digital Subscriber Line (DSL) networks, optical networks, DOCSIS networks, and Low Earth Orbit (LEO) Satellite networks. These networks can provide internet access to devices and can be used for offloading data and data sessions from 3GPP networks.

In the context of mobile communications, 3rd Generation Partnership Project (3GPP) networks refer to cellular networks that are based on standards developed by the 3GPP organization. These networks, which include 3G, 4G, and 5G technologies, are designed to provide wide area coverage and support for high-speed data transmission.

Offloading refers to the process of transferring data sessions from a 3GPP network to a non-3GPP network, such as a WLAN. This can be beneficial in scenarios where the 3GPP network is congested or where the non-3GPP network can provide a better quality of service. For example, a user might offload data from a cellular network to a home or office WLAN to achieve faster download speeds or to conserve cellular data usage.

User Equipment (UE) is a term used in mobile telecommunications to refer to a device, such as a smartphone or tablet, that is used by an end-user to access network services. The UE includes both the hardware, such as the radio and processor, and the software that controls its operation.

In some scenarios, the WLAN functionality on the UE may be disabled. This could be due to user preference, power saving measures, or other factors. When the WLAN functionality is disabled, the UE cannot connect to a WLAN and therefore cannot offload data from the 3GPP network.

Multi-Link Sensing (MLS) is a technique that involves using multiple wireless links to sense the radio frequency (RF) environment. This can include sensing signals from different wireless technologies, such as WLAN and cellular, as well as sensing physical parameters such as temperature, infrared patterns, and visual data via cameras. The data obtained from MLS can be used to determine various characteristics of the environment, which can in turn be used to make decisions about network connectivity and offloading.

### SUMMARY OF INVENTION

The present disclosure provides a method for controlling a user equipment (UE) using multi-link sensing (MLS) to offload data sessions from a 3GPP network to a non-3GPP network via a WLAN when the WLAN functionality is initially disabled at the UE. This system and method involves receiving an MLS signal associated with a radio frequency (RF) environment and/or a physical environment at a UE. The received MLS signal is processed to determine an environmental signature, which is then compared against one or more RF environmental signatures stored in memory. These stored signatures are associated with the WLAN providing wireless access to the non-3GPP network. Based on this comparison, the WLAN functionality at the UE is enabled to facilitate the offload of data sessions from the 3GPP network to the non-3GPP network in the RF environment.

In one aspect of the present systems and methods, the system and method involve receiving one or more MLS signals associated with a radio frequency (RF) environment and/or a physical environment at a UE. The received MLS signal is processed to determine an environmental signature, which is then compared against one or more RF environmental signatures stored in memory. These stored signatures are associated with the WLAN providing wireless access. Based on this comparison, the UE notifies the user via one or more output devices, such as the screen and/or an auditory output, that the UE is within a WLAN functional environment. Optionally, WLAN ON/OFF functionality is provided to the user via the UE such that the user may manually activate the WLAN functionality. It will be understood that opposite is contemplated, that is the MLS functionality may be utilized to determine the UE is no longer in a WLAN functional environment such that the WLAN functionality may be deactivated.

In some aspects, the RF environmental signature may include information associated with a topographical arrangement of substantially stationary objects in the RF environment. The RF environment may include two or more WLAN Access Points. The stored RF environmental signatures may contain data associated with objects, targets, and at least a partial map of the physical and/or RF environment. The stored signatures may also include UE connection information associated with known wireless devices in the RF environment.

In other aspects, the method may involve migrating data sessions from the 3GPP network to the offload non-3GPP network after the offload non-3GPP network is enabled. The method may also involve non-3GPP sensors, which could be image cameras, video cameras, LiDAR sensors, sonar sensors, infrared sensors, satellite navigation sensors, proximity sensor devices, New Radio Proximity Services (NR ProSe) devices, Ultra-wideband (UWB) devices, IEEE 802.11 devices, IoT transceivers, and Wi-Fi sensing devices.

The present disclosure also provides a method for offloading data sessions from a 3GPP network to a non-3GPP network having a Wireless Local Area Network (WLAN) interface when a WLAN functionality is initially disabled at a UE. This method involves receiving MLS data at a UE wireless receiver, processing the received MLS data to determine if the MLS data is associated with a wireless environment having a previously prepared WLAN association, enabling the WLAN functionality on the UE, connecting to the non-3GPP network via the previously prepared WLAN association, and migrating data sessions from the 3GPP network to the non-3GPP network.

Additionally, the present disclosure provides a method for offloading data sessions from a 3GPP network to a non-3GPP network via a WLAN Access Point (AP) when a WLAN functionality is initially disabled at a UE. This method involves receiving MLS data at a wireless receiver of a WLAN AP, processing the MLS data to determine the presence of the UE, transmitting an AP-to-UE signal to the UE to enable the WLAN functionality on the UE, and connecting the UE to the non-3GPP network via the WLAN AP. This method may also involve facilitating the offload of data sessions from the 3GPP network to the non-3GPP network.

In addition to the methods for controlling a user equipment (UE) using multi-link sensing (MLS) to offload data sessions from a 3GPP network to a non-3GPP network via WLAN, the present disclosure also contemplates systems for implementing such methods. The systems may include a UE with a wireless receiver, a computational processor, and a memory storing RF environmental signatures. The system may further include a WLAN functionality that can be enabled or disabled based on the comparison of determined RF environmental signatures against stored signatures. The system may also include non-3GPP sensors for collecting additional environmental data, and an interface for communicating with a WLAN ON/OFF function to control the WLAN functionality based on the processing of MLS signals.

In some aspects, the system may be configured to perform operations such as receiving MLS signals and/or MLS data acquisition, processing these signals and/or data to determine an environmental aspect, comparing the determined environmental aspects against stored signatures, and enabling or disabling WLAN functionality to facilitate data session offloading. The system may also be capable of migrating data sessions from the 3GPP network to the non-3GPP network, receiving non-3GPP sensing data, and transmitting data to facilitate the control of the WLAN functionality.

Furthermore, the system may include a plurality of devices forming a sensing group for generating MLS data with improved resolution, and may utilize various sensing techniques such as monostatic, bistatic, and multistatic sensing to enhance the accuracy and reliability of the environmental sensing. The system may be initiated by various entities including the UE, an access point, or a client, and may involve the use of different wireless protocols and networks to achieve the desired offloading and sensing functionalities.

### BRIEF DESCRIPTION OF FIGURES

FIG. 1 illustrates a system for multi-link sensing assisted WLAN offload enablement, in an embodiment.

FIG. 2A depicts a system showing multilink sensing functionality and fingerprinting functionality in a user equipment (UE), in an embodiment.

FIG. 2B depicts a system showing multi-link sensing functionality and fingerprinting functionality in a multi-link sensing device, in an embodiment.

FIG. 3 presents a floor plan of a house with various devices, access points, and physical features which may be leveraged by multi-link sensing functionality to enable non-3GPP network offload via a WLAN, in an embodiment.

FIG. 4 shows a system with a user equipment at home connected to a WLAN network and a cellular network, in an embodiment.

FIG. 5 provides a sequence diagram illustrating the process of multi-link sensing assisted WLAN offload initiated by the WLAN, in an embodiment.

FIG. 6 depicts a sequence diagram illustrating a process of Multi-Link Sensing assisted WLAN offload initiated by MLS device(s), in an embodiment.

FIG. 7 presents a sequence diagram illustrating a process of Multi-Link Sensing assisted WLAN offload initiated by the user equipment, in an embodiment.

FIG. 8 depicts a system for a UE at home connected to a WLAN network and a cellular network leveraging 3GPP's ATSSS functionality or ARC mobile functionality, in an embodiment.

FIG. 9 illustrates a sequence diagram illustrating a process of Multi-Link Sensing assisted ATSSS enablement, in an embodiment.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner and/or visual and non-visual camera. Furthermore, in the exemplary embodiment, additional output channels may include, but not be limited to, an operator interface monitor.

Further, as used herein, the terms “software”, “firmware”, and “instructions” are interchangeable and include any computer program storage in memory for execution by personal computers, workstations, clients, servers, processor, processing device, computing device, controller, and respective processing element(s) thereof.

As used herein, the term “non-transitory computer-readable media” is intended to be representative of any tangible computer-based device implemented in any method or technology for short-term and long-term storage of information, such as, computer-readable instructions, data structures, program modules, and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

The present embodiments are described below with respect to several components of a conventional cable and/or wireless/Wi-Fi networks. Optical networks though, are also contemplated within the scope of the present embodiments. Such optical networks may include, without limitation, an Optical Network Terminal (ONT) or Optical Line Termination (OLT), and an Optical Network Unit (ONU), and may utilize optical protocols such as PON, EPON, RFOG, GPON, and CPON. Other types of communication systems our further contemplated, including communication systems capable of x-hauling traffic, satellite operator communication systems, MIMO communication systems, microwave communication systems, short and long haul coherent optic systems, etc. X-hauling is defined herein as any one of or a combination of front-hauling, backhauling, and mid-hauling data traffic.

In these additional embodiments, the MTS may include, without limitation, a termination unit such as an ONT, an OLT, a Network Termination Unit, a Satellite Termination Unit (GEO, MEO, LEO, very LEO (VLEO)), a Cable MTS (CMTS), a mobile core, a DSL termination unit, or other termination systems collectively referred to herein as “Modem Termination Systems (MTS)”. Similarly, the modem described above may include, without limitation, a cable modem (CM), a satellite modem (GEO, MEO, LEO, Very LEO (VLEO)), an Optical Network Unit (ONU), a DSL unit, an eNodeB, a gNodeB, a DSL modem, etc., which are collectively referred to herein as “modems.” Furthermore, the DOCSIS protocol may be substituted with, or further include protocols such as PON, EPON, RFOG, GPON, CPON, Satellite Internet Protocols, a DSL protocol, without departing from the scope of the embodiments herein.

The systems and methods described herein are not limited by the networking protocol described in the examples and can be applied to a plurality of network systems and types, alone or in combination. These systems and types can include, but are not limited to, DOCSIS, 3GPPS 5G technology, optical networks, Low Earth Orbit (LEO) networks, ethernet based networks, IEEE systems (e.g., 802.11 and 16), 5G/MIMO (multiple input multiple output) (OFDM (orthogonal frequency-division multiplexing), BDMA), 4G LTE, 4G (CDMA) WiMAX, 3G HSPA+/UMTS (WCDMA/CDMA), 2G/GSM (TDMA/CDMA), Wi-Fi (all), Optical (PON/CPON/etc.), Ethernet (all: 10Base2, 10Base5, 10BaseT, 100BaseTX, 100Base FX, 1000Base SX, 1000Base LX, etc.), DSL, and RAN, for non-limiting examples.

As used herein, the following terms are defined as follows:

WLAN (Wireless Local Area Network): A type of wireless network that allows devices to wirelessly connect to an access network and communicate without the use of physical wired connections, one common example of which is based on the IEEE 802.11 standard, often referred to as Wi-Fi.

Non-3GPP Network: Refers to networks that are not based on the standards developed by the 3rd Generation Partnership Project (3GPP) organization, including various types of wired and wireless networks such as DSL, optical, DOCSIS, and LEO Satellite networks, which are often implemented with a local area network (LAN) and/or WLANs.

3GPP Network: Cellular networks that are based on standards developed by the 3GPP organization, including technologies such as 3G, 4G, 5G, 6G and future generations designed to provide wide area coverage and high-speed data transmission.

Offloading: The process of transferring data traffic and/or data sessions from a 3GPP network to a non-3GPP network, which can be beneficial in scenarios where the 3GPP network is congested or the non-3GPP network can provide a better quality of service.

User Equipment (UE): A device used by an end-user to access network services, including both the hardware (radio and processor) and the software that controls its operation.

Multi-Link Sensing (MLS): A technique that involves using multiple wireless links and sensors to sense a radio frequency (RF) and/or physical environment, including signals from different wireless technologies and physical parameters such as temperature, infrared patterns, visual data, audio data, RF generated topographical/physical environment information, and LIDAR data.

Multi-Link Sensing (MLS) Information: information generated by MLS techniques and sensors relating to the radio frequency (RF) and physical environment around an MLS device, which includes, but is not limited to, RF signals data, RF reflection data, RF source identification data, wireless technologies data, GPS data, location data, and physical parameters such as temperature data, infrared patterns, visual data, audio data, RF generated topographical/physical environment information, and LIDAR data.

Environmental Signature: Generic information processed from an MLS signal that characterizes the RF and/or physical environment, which can be compared against stored signatures to make decisions about network connectivity and offloading. This is also called a “Fingerprint” herein as it identifies unique environments or locations for comparison to known environments or locations stored in memory, called herein “surroundings fingerprint”.

RF Environmental Signature: Information that may include the topographical arrangement of substantially stationary objects in the RF environment and is used to identify the presence of a WLAN providing wireless access to a non-3GPP network. This is also called a “RF Fingerprint” herein as it identifies unique environments or locations for comparison to known environments or locations stored in memory, called herein “surroundings fingerprint”.

Physical Environmental Signature: Information processed from MLS data that characterizes the physical aspects of an environment, which may include the layout, dimensions, and features of a space. This signature can be used to identify and differentiate between various physical locations by comparing against physical environmental signatures stored in memory. The physical environmental signature may also incorporate data from non-3GPP sensors such as visual, LIDAR, thermal, acoustic characteristics, and physical characteristic information generated from RF signals in the space that contribute to the uniqueness of a physical environment. This is also called a “Physical Fingerprint” herein as it identifies unique environments or locations for comparison to known environments or locations stored in memory, called herein “surroundings fingerprint”.

Non-3GPP Sensors: Sensors, not defined by the 3GPP standard, capable of generating RF environmental signatures and physical environmental signatures. These devices may include, but are not limited to, image cameras, video cameras, LiDAR sensors, sonar sensors, infrared sensors, satellite navigation sensors, proximity sensor devices, NR ProSe devices, UWB devices, IEEE 802.11 devices, IoT transceivers, and Wi-Fi sensing devices, used for collecting additional environmental data.

WLAN ON/OFF Function: An interface or control mechanism that enables or disables the WLAN functionality on the UE based on the processing of MLS signals.

ATSSS (Access Traffic Steering, Switching, and Splitting): A 3GPP functionality that allows for the steering, switching, and splitting of user data between 3GPP and non-3GPP networks to optimize network usage and performance.

ARC (Adaptive Route Control): A CableLabs defined functionality similar to ATSSS that enables dynamic routing of traffic between different networks for improved performance and efficiency.

MLS initiator: an entity or device that begins the process of multi-link sensing by transmitting an MLS signal. The MLS initiator may be a user equipment (UE), a 3GPP access point, a non-3GPP access point, an IoT Hub, a client, or a second UE. The MLS initiator's role is to send out signals that can be detected and measured by other devices, such as the UE or MLS responders, to assess the RF and/or physical environment for the purpose of enabling WLAN functionality, offloading data sessions, or other network management tasks. The MLS initiator may utilize various wireless protocols and technologies to generate the MLS signal, which can include, but are not limited to, signals defined by 3GPP standards, IEEE 802.11 standards, Bluetooth, and other communication standards that support sensing and data transmission.

MLS responder: a device or system component that receives and responds to MLS signals transmitted by an MLS initiator. The MLS responder may be a user equipment (UE), a WLAN access point, a non-3GPP access point, an IoT device, or any other network entity capable of participating in multi-link sensing activities. The MLS responder's role is to provide feedback or data that can be used to assess the RF and physical environment, which in turn can be used to make decisions about network connectivity, such as enabling WLAN functionality or offloading data sessions. The MLS responder may utilize various wireless protocols and technologies to receive and process the MLS signals and may also transmit signals that contribute to the multi-link sensing process.

The present disclosure relates to systems and methods for controlling a user equipment (UE) utilizing multi-link sensing (MLS) to offload one or more data sessions from a 3GPP network to a non-3GPP network via a WLAN when a WLAN functionality is initially disabled at the UE. The systems and methods involve receiving an MLS signal and or data associated with one or both of a radio frequency (RF) environment and a physical environment at one or more UE wireless receiver of the UE and/or other UE sensors. The received MLS signal and data are processed by a computational processor to determine an environmental signature. This determined RF environmental signature is compared against one or more RF and or physical environmental signatures stored in memory, which are associated with the WLAN providing wireless access to the non-3GPP network. Based on this comparison, the WLAN functionality at the UE is changed from a disabled state to an enabled state to facilitate the offload of at least one of the one or more data sessions from the 3GPP network to the non-3GPP network via the WLAN.

In some aspects, the RF and or physical environmental signature may include information associated with a topographical arrangement of substantially stationary objects in the environment. The environment may include two or more WLAN Access Points. One or more environmental signatures stored in memory may contain data associated with one or more objects in the environment, targets in the environment, RF transmitters, RF reflections, and at least a partial map (physical and/or RF) of the environment. The one or more environmental signatures stored in memory may also include UE connection information associated with one or more known WLAN devices or other devices utilizing, for example, unlicensed or partially licensed spectrum in the environment.

In some cases, the RF environment may include one or more of an IoT device, an IoT Hub, a Wi-Fi Access Point (AP), a Wi-Fi Station (STA), a Wi-Fi mesh AP, a radio head as defined by a 3GPP standard, a LoRa WAN AP, a Helium AP, and a Citizens Broadband Radio Service (CBRS) radio head. The RF environmental signature may include information associated with an arrangement of one or more of IoT devices, IoT Hubs, Wi-Fi Access Points (APs), Wi-Fi Stations (STAs), and wireless mesh networks.

In some aspects, the systems and methods may include migrating one or more data sessions from the 3GPP network to the off-load non-3GPP network after the WLAN connection to the off-load non-3GPP network is enabled. To determine the physical aspects of the environment, the systems and methods may utilize non-3GPP sensors, which could be one or more of an image cameras, a video camera, a LiDAR sensor, a sonar sensor, an infrared sensors, a satellite navigation sensor, a proximity sensor device, a New Radio Proximity Services (NR ProSe) device, a Ultra-wideband (UWB) device, an IEEE 802.11 device, a Bluetooth sensor, a Near Field Communication (NFC) sensor, and a Wi-Fi sensing device. Data from these types of devices are then processed by MLS functionality to determine if the UE is at a location that is in wireless communication proximity to a WLAN enabled non-3GPP access network. Such information can be used to change the UEs WLAN functionality from a disabled state to an enable state to facilitate offload of data or data sessions from the 3GPP network to the non-3GPP network.

In some cases, the systems and methods may further comprise receiving at one or more non-3GPP sensing data associated with one or both of a radio frequency (RF) environment and a physical environment. The non-3GPP sensing data could be one or more of camera data, video data, LiDAR data, sonar data, infrared sensor data, 802.11 data, satellite navigation data, and so on. The systems and methods may also comprise transmitting data generated in one or both of the processing step and the comparing step to a WLAN ON/OFF function to enable or disable the WLAN functionality of the UE.

It should also be understood that multi-link sensing does not substantially impact a UE's normal operation or battery life, and therefore has little to no adverse impact on customer experience. This is due to multi-link sensing utilizing the normal operation and output of the MLS sensors for processing by MLS functionality to affect the WLAN function and access network off-load.

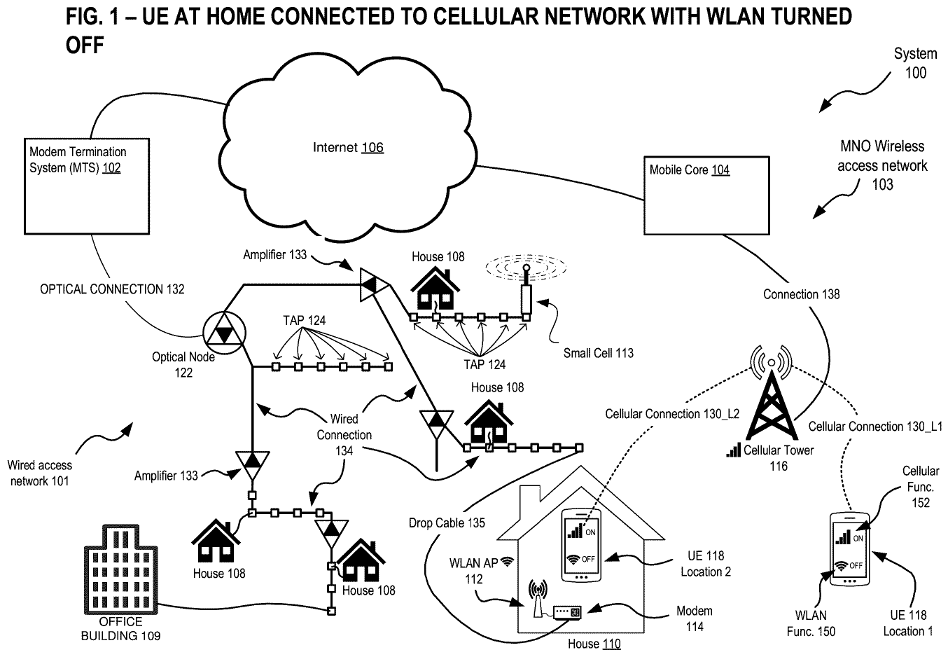

FIG. 1 shows a system 100 for multi-link sensing assisted WLAN offload enablement. In system 100 WLAN functionality is disabled at a UE 118, preventing the offloading of data traffic from the 3GPP network to the non-3GPP network.

System 100 includes a WLAN enabled off-load access network 101 (sometimes called a non-3GPP network herein) and a Mobile Network Operator (MNO) wireless access network 103 (sometimes called a 3GPP network herein). The off-load access network 101 connects multiple residential houses 108, 110 and an office building 109 to the internet 106 via various components such as drop cables 135, taps 124, wired connections 134, amplifiers 133, an optical node 122, an optical connection 132, and a modem termination system (MTS) 102, which is connected to internet 106. House 110 is shown to include a modem 114 connected to drop cable 135 and to WLAN AP 112, which provides wireless access to network 101 within house 110. A 3GPP defined small cell 113 is also part of the access network 101, enhancing connectivity for wired access network customers.

The wireless access network 103 includes a cellular tower 116 providing cellular connections 130, with specific connections at location 1 (130_L1) and location 2 (130_L2), to a user equipment (UE)/mobile device 118. The tower 116 is also in communication with a mobile core 104 via connection 138, which intern is connected to the internet 106.

In some aspects, the access network 101 may be any wired network, optical network, or hybrid network. In other cases, network 101 may even be a wireless access network that is WLAN enabled for the purpose of offloading traffic from a cellular or 3GPP defined network. Non-limiting examples of possible network 101 wireless access network include a second 3GPP access network, such as a fixed wireless access network, a satellite network (GEO, MEO, LEO, VLEO), a Wireless Internet Service Provider (WISP) network, a microwave or line of sight network, and a converged wireless-wireline network.

The UE 118 is shown with WLAN functionality 150 turned off, relying on cellular functionality 152 and cellular connections 130 for data transmission. When the UE 118 moves to location 2 at house 110 with connections 130_L2 and WLAN functionality 150 is still in an “off” state, the UE 118, its user, and operator of network 101 are not benefiting from WLAN traffic offload capability from wireless access network 103 to network 101 via WLAN AP 112 providing unlicensed wireless access to network 101.

In some cases, enabling and disabling WLAN functionality 150 on UE 118 is a manual process performed by a user interaction. For example, if UE 118 has a “sticky AP” issue a user may manually turn off WLAN functionality 150 and may forget to turn it back on later, thus it remains in a disabled state. In other cases, enabling and disabling WLAN functionality is performed, intentionally or unintentionally, by the UE, by a UE update, or software on the UE. For example, WLAN functionality 150 may be turned off by a software or operating system update or applications running on the UE.

In some aspects, the RF environment may include two or more WLAN Access Points, for example in a mesh network configuration. The systems and methods involve receiving an MLS signal and/or data at an MLS device, such as a UE wireless receiver (UE 118), associated with a radio frequency (RF) environment and/or a physical environment. The systems and methods involve processing the received MLS signal and/or data to determine an environmental signature using a computational processor. The systems and methods involve enabling the WLAN functionality at the UE to facilitate the off-load of at least one of the one or more data sessions or data traffic from the 3GPP network to the non-3GPP network via the WLAN.

In some aspects, one or more Access Points may serve as MLS responders, actively participating in the sensing process. These MLS responders are configured to transmit specific MLS signals that can be detected and measured by the UE wireless receiver (UE 118) to assess the RF and physical environment. Upon receiving these MLS signals, the UE processes the data using a computational processor to extract an environmental signature. This signature is indicative of the RF characteristics and may include information such as signal strength, frequency, and phase shift, which are influenced by the presence and arrangement of objects within the environment. By comparing the determined environmental signature against known signatures stored in memory, the UE can ascertain its proximity to the WLAN and make informed decisions about network connectivity. If the comparison suggests that the UE is within a favorable WLAN coverage area, the system methods involve enabling the WLAN functionality at the UE. This enables the UE to off-load at least one of the one or more data sessions or data traffic from the 3GPP network to the off-load access network, thereby optimizing network usage and improving overall data transmission efficiency in the RF environment.

In some aspects, system 100 may include a UE 118 that is mobile and registered with the operator of the off-load access network 101. The operator of network 101 may not have a widespread or even any 3GPP defined wireless functionality in their network 101. As such, the operator of network 101 may have entered into a Mobile Virtual Network Operator (MVNO) agreement with the mobile network operator (MNO) of network 103. The MVNO agreement may require the operator of network 101 to pay the operator of network 103 for any network 101 user data or data sessions that are carried over network 103. As such, the operator of network 101 would benefit from as much data traffic on network 101 as possible. In addition, network 101 may have specialized and/or advanced functionality that is not supported by network 103, which the user of UE 118, who pays the operator of network 101 for services, would like to have access to. Some examples of advanced features may include low latency, higher throughput, increased security, micro-network segmentation, edge compute, edge storage, user-centric privacy, virtualized network functions (VNF), bespoke broadband, Access Traffic Steering, Switching and Splitting (ATSSS), Adaptive Route Control (ARC) Hotspot, ARC mobile, etc.

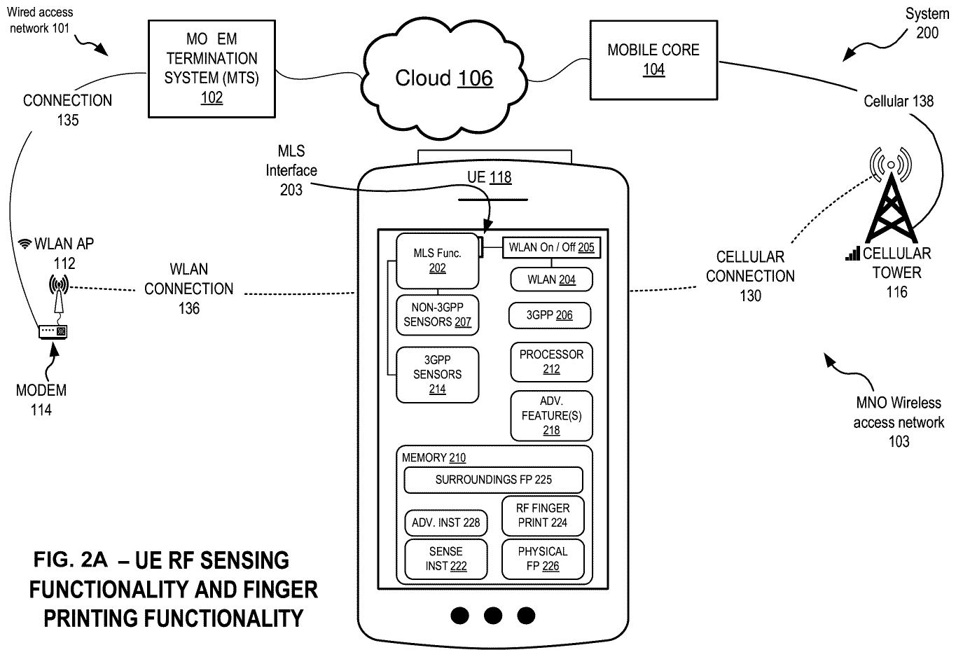

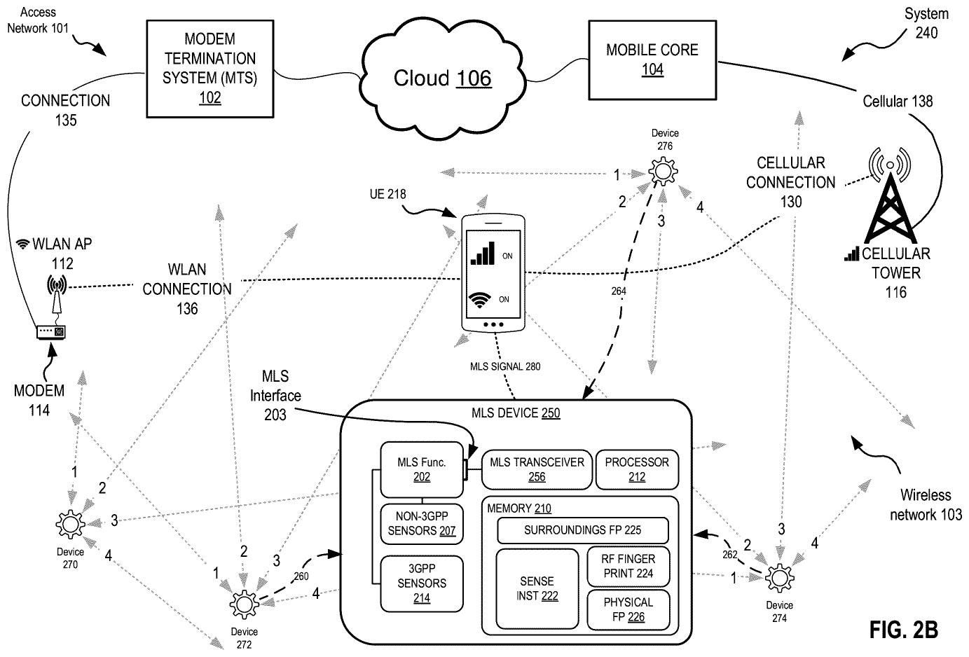

FIG. 2A shows a system 200 for multilink sensing functionality and fingerprinting functionality, with UE 118 presented with details of logical functions. The system 200 shows access network 101 for providing user equipment (UE) 118 access to the internet 106 and wireless access network 103, which provides UE 118 access to the internet 106 via wireless protocols and functionality as defined by 3GPP, as similarly described in system 100, FIG. 1.

The UE 118 is shown with logical components and functionalities for multilink sensing and environmental signatures/fingerprinting, which are used to switch WLAN functionality from a disabled state to an enabled state facilitating wireless access to network 101. These logical components may be realized through hardware, software, or a combination thereof, and may consist of single or multiple cooperating elements that alone or together enable the functionalities described. The coordination and functioning of these elements are subject to design choices and implementation strategies, as such the logical elements are shown here. In the example of system 200, UE 118 includes a Multilink Sensing (MLS) functionality 202, an MLS interface 203, a WLAN functionality 204, a WLAN ON/OFF function 205, a 3GPP function 206, non-3GPP sensors 207, a memory 210, a processor 212, 3GPP sensors 214, advanced features 218, sensing instructions 222, an Radio Frequency (RF) fingerprint 224, surroundings fingerprint (FP) 225, a physical fingerprint 226, and advanced instructions 228.

MLS functionality 202 executes sense instructions 222 to identify the radio frequency and/or physical environment UE 118 is located in. It will be understood that MLS functionality 202 executing sense instructions 222 may be, for example, processor 212 executing instructions 222, or alternatively may be a dedicated MLS processor (not shown), configured with MLS functionality 202, executing instructions 222. As stated above, MLS functionality 202 and the other functions, are logical representation of physical or virtual hardware, software, or a combination of hardware, virtual hardware, and software. The MLS sensing process may be continuous, periodic, random, or event driven. Executing instructions 222 may cause MLS functionality 202 to acquire data from UE 118's 3GPP sensors 214 and non-3GPP sensors 207 which generates an environmental signature/fingerprint of UE 118's surroundings, which may be stored in memory as surroundings fingerprint 225. 3GPP sensors 214 may include those defined by the 3GPP standard (see for example 3GPP TR 22.837 V19.2.1 (2024 February) titled “3rd Generation Partnership Project; Technical Specification Group TSG SA; Feasibility Study on Integrated Sensing and Communication”, incorporated herein by reference in its entirety), which are configured to expose sensing results to third-party applications such as utilized by the present systems and methods. Non-3GPP sensors may include one or more of image cameras, video cameras, LiDAR sensors, sonar sensors, infrared sensors, satellite navigation sensors, proximity sensor devices, NR ProSe devices, UWB devices, IEEE 802.11 devices, IoT transceivers, and Wi-Fi sensing devices, used for collecting RF and/or physical environmental data.

As stated above, 3GPP sensors 214 and non-3GPP sensors 207 provide RF and/or physical environmental data to MLS functionality 202, which utilizes that data to generate environmental signatures/fingerprints of UE 118's surroundings, stored in memory as surroundings FP 225. MLS functionality 202 may then perform a comparison step to compare the fingerprint data stored in surroundings FP 225 with previously stored environmental signatures/fingerprints, i.e., RF fingerprint 224 and physical fingerprint 226 stored in memory 210. RF fingerprint 224 and physical fingerprint 226 store environmental signatures/fingerprints are associated with locations where UE 118 has access to a WLAN AP, one example of which is WLAN AP 112, in communication with a non-3GPP access network, such as network 101. It will be understood that RF fingerprint 224 and physical fingerprint 226 may be separate data stores, as shown in system 200, or may be a single data store which contains data associated with one or both of RF fingerprint 224 and physical fingerprint 226 and may also contain a combined data representing the RF and physical environment. Data stored in RF fingerprint 224 and physical fingerprint 226 may include actual data from sensors 207, 214 or store data representative of data derived from sensors 207, 214.

The outcome of the comparison process performed by MLS functionality 202 may determine UE 118 is in wireless communication proximity to WLAN AP 112 and network 101. If this is the case and if WLAN functionality 150, 204 on UE 118 is in a disabled state, MLS functionality 202 may output, via MLS interface 203, a command to WLAN ON/OFF function 205 to change WLAN functionality 204 from the disabled state to an enabled state thereby providing wireless access to off-load access network 101. This facilitates the integration of various sensing and communication functionalities to enable WLAN offload to network 101 in part or in whole.

The MLS interface 203 takes inputs from non-3GPP sensors 207 and 3GPP sensors 214 for processing. The MLS interface 203 outputs a command to WLAN ON/OFF function 205 based on its processed inputs. This facilitates the integration of various sensing and communication functionalities to enable WLAN offload to network 101 in part or in whole.

In some cases, the method involves receiving, at one or more non-3GPP sensors 207 associated with the UE 118, sensing data associated with one or both of a radio frequency (RF) environment and a physical environment. The non-3GPP sensing data may be one or more of camera data, video data, LiDAR data, sonar data, infrared sensor data, 802.11 data, and satellite navigation data. This data can be used to determine the environmental conditions around UE 118 and can be used to inform decisions about network connectivity. Machine learning algorithm, such as neural networks trained in pattern recognition of environmental signatures may be utilized in determine environmental signatures.

In some aspects, the method may further comprise transmitting data generated in one or both of the processing step and the comparing step to a WLAN ON/OFF function 205 to enable or disable the WLAN functionality of UE 118. This can allow for dynamic adjustment of the WLAN functionality based on the sensed environmental conditions, potentially improving network performance and user experience.

In some aspects, the UE 118 (or MLS device) may utilize one or more Physical layer Protocol Data Unit (PPDU) for use as an MLS signal. This signal can be processed by the MLS functionality 202 to determine the RF and/or physical environmental signature. The determined RF and/or physical environmental signature is then compared against one or more RF environmental signatures stored in memory 210, as described above. The one or more RF environmental signatures stored in memory 210 may contain data associated with one or more objects in the RF environment, targets in the RF environment, and at least a partial map of the RF environment. In other aspects, the UE 118 (or MLS device) may utilize a Directional Multi Gigabit (DMG) sensing protocol.

In some cases, an MLS initiator can be one of the UE 118, a 3GPP access point, a non-3GPP access point, an IoT Hub, a client, or a second UE. The MLS initiator can initiate the process of multi-link sensing by transmitting an MLS signal to UE 118. Upon receiving the MLS signal, the UE 118 can process the signal to determine if the MLS data, i.e., the environmental signature/fingerprint, is associated with a wireless environment having a previously prepared WLAN association, e.g., associated with data stored in surroundings FP 225. If the determined environmental signature/fingerprint matches one of the ones stored in surroundings FP 225, the WLAN functionality at the UE 118 may be enabled, facilitating the off-load of at least one of the one or more data sessions from the 3GPP network to the non-3GPP network.

In some aspects, an MLS responder can be UE 118. The MLS responder can receive the MLS signal from the MLS initiator and process the signal to determine the RF environmental signature. The determined RF environmental signature can then be used to enable the WLAN functionality at UE 118.

In some embodiments, UE 118 may be both the MLS initiator and the MLS responder, responding to its own MLS initiation signal. In other embodiments, other devices in the RF environment capable of MLS functionality may be both the MLS initiator and the MLS responder, identifying UE 118 presence and sending a signal to UE 118 for processing by MLS functionality 202 for enabling WLAN functionality 204 via MLS interface 203 and WLAN On/Off function 205.

In some cases, the systems and methods may involve receiving Multi Link Sensing (MLS) Data at a wireless receiver of the UE 118, where the MLS data is one or both of a wireless sensing signal(s) and a wireless sensing data. The received MLS data can be processed to determine if the MLS data is associated with a wireless environment having a previously prepared WLAN association. If the determined RF environmental signature matches one of the RF environmental signatures stored in memory 210, the WLAN functionality at the UE 118 may be enabled, facilitating the off-load of at least one of the one or more data sessions from the 3GPP network to the non-3GPP network in the RF environment.

In some cases, the method involves migrating one or more data sessions from the 3GPP network to the non-3GPP network. This can be achieved, initially, by enabling the WLAN functionality at UE 118, connecting the UE 118 to the non-3GPP network via the WLAN, and transferring the data sessions from the 3GPP network to the non-3GPP network. This would not be possible if the WLAN functionality 204, 150 on UE 118 remained in a disabled state. Optionally, migrating the data session or data traffic from network 103 to network 101 may be further facilitated by processor 212 executing advanced instructions 228 to initiate a data traffic or data session transfer from network 103 to network 101 via WLAN AP 112. Optionally, migrating the data session or data traffic from network 103 to network 101 may be further facilitated by processor 212 executing advanced instructions 228 to prioritize the WLAN AP 112/network 101 connection and deprioritize the network 103 connection.

In some aspects, the wireless sensing signal(s) and the wireless sensing data is defined by one or more of the 3GPP standard, the IEEE 802.11bf standard, the Bluetooth protocol, the Wi-Fi Alliance (WFA), the Wireless Broadband Alliance (WBA) standard, the Connectivity Standards Alliance/Matter (CSA/Matter) standard, and the IEEE 802.11 standards. These standards define the protocols and technologies used for wireless communication and can be used to generate the wireless sensing signal(s) and the wireless sensing data.

In some cases, the wireless sensing signal(s) and the wireless sensing data is generated from one or more of a Wireless Personal Area Network (WPAN), WLAN, and Wireless Wide Area Network (WWAN). These networks provide wireless connectivity and can be used to generate the wireless sensing signal(s) and the wireless sensing data.

In some cases, WLAN functionality 204 of the UE 118 may utilize one or more unlicensed spectrum. This can provide additional bandwidth for data transmission and can improve the performance of WLAN functionality 204. In some aspects, the network utilizing unlicensed spectrum may be a 5G New-Radio Unlicensed (5G NR-U) network. The 5G NR-U network can provide high-speed data transmission and can support a wide range of applications and services.

FIG. 2B shows a system 240 for multilink sensing functionality and fingerprinting functionality, with the bulk of the MLS functionality configured with one or more dedicated MLS devices.

System 240 is similar to system 200 of FIG. 2A, showing access network 101 capable of providing a user equipment (UE) 218 (similar to UE 118 of FIG. 2A) access to internet 106 and wireless access network 103, which is also capable of providing UE 218 wireless access to the internet 106 via wireless protocols and functionality as defined by 3GPP, which is also similarly described in system 100, FIG. 1.

Two differences between system 200 and system 240 are (1) system 240 shows MLS device 250 and (2) multiple MLS participating devices 270-276. Systems 200 and 240 are shown separately for sake of clarity and ease of explanation, and it will be understood all elements of systems 200 and 240 may coexist and cooperate in a blended environment.

MLS Device 250 is shown with logical components and functionalities for multilink sensing and environmental signatures/fingerprinting, similar to those shown for UE 118 in system 200. That is, MLS device 250 includes MLS function 202, MLS interface 203, non-3GPP sensors 207, 3GPP sensors 214, memory 210, and processor 212. MLS device 250 further includes an MLS transceiver 256. MLS transceiver 256 is configured to receive signals and data from MLS participating devices 270-276 (e.g., signals 260, 262, and 264). Optionally, WLAN AP 112, the RF environment, and other devices participating or utilized to assist the multi-link sensing operations may also cooperate with MLS device 250 via MLS transceiver 256, and sensors 207, 214. MLS transceiver 256 may also transmit its own MLS signal into the RF environment for multi-link sensing operations, to provide instructions to MLS participating devices 270-276 and/or WLAN AP 112, and to communicate with UE 218, e.g., via a signal 280. Memory 210 includes sensing instructions 222, surroundings FP 225, RF fingerprint 224, and physical fingerprint 226. More or fewer components, software elements, data types, and instructions may be included to satisfy the MLS enablement of a WLAN function on UE 218 without departing from the scope here.

MLS participating devices 270-276 are each shown with lines 1-4. Lines 1-4 represent MLS sensing for observing the RF and/or physical environment. This means lines 1-4 symbolically depict multi-link sensing coverage of a space, where MLS coverage may be performed by mechanisms and sensors including 3GPP sensors and non-3GPP sensors. 3GPP sensors may include those defined by the 3GPP standard (see, for example, 3GPP TR 22.837 V19.2.1 (2024 February) titled “3rd Generation Partnership Project; Technical Specification Group TSG SA; Feasibility Study on Integrated Sensing and Communication”, incorporated herein by reference in its entirety), which are configured to expose sensing results to one or both of MLS device 250 and UE 118, 218. Non-3GPP sensors may include one or more of image cameras, video cameras, LiDAR sensors, sonar sensors, infrared sensors, satellite navigation sensors, proximity sensor devices, NR ProSe devices, UWB devices, IEEE 802.11 devices, IoT transmitters and/or receivers, and Wi-Fi sensing devices, used for collecting RF and/or physical environmental data. Each of MLS participating devices 270-276 may include one or more of the listed 3GPP sensors and non-3GPP sensors. Lines 1-4 for each device 270-276 are symbolically represented as straight lines for sake of clarity and to ease explanation, but it will be appreciated by the skilled artisan these may be highly complex patterns of reception, transmission-reception, and/or transmission of electromagnetic waves (e.g., RF signals, light, lasers, etc.), pressure waves (sonar, echo, vibration, etc.), and/or thermal signals, to name only a few of the methods and signals that can be used in multi-link sensing.

MLS participating devices 270-276 may be dedicated MLS devices, may be existing device at a location or in an environment that include or are modified to include MLS functionality, and/or maybe a device determined by an MLS device, such as MLS device 250, to be used as an MLS participating device via its normal functionality. Examples of devices 270-276 as dedicated MLS devices may be, for example, devices 270-276 being substantially similar to MLS device 250 for cooperative functionality or being “satellite devices”/subordinate devices with reduced functionality relative to MLS device 250 designed to sense the RF and/or physical environment and for relaying environmental sensing data to MLS device 250 for processing. Other examples of devices 270-276 as existing devices at a location or in an environment that include or are modified to include MLS functionality are devices that incorporate, either necessarily or optionally, MLS sensing functionality, such as a device defined by or utilizing the 802.11 standard, a device defined by or utilizing the 3GPP standard, a device defined by or utilizing one of the IoT standards, a device leveraging a specification defined by the Wireless Broadband Alliance, Inc.© (WBA), the Wi-Fi Alliance® (WFA), CableLabs©, etc. Alternatively or additionally, examples of devices 270-276 as existing device at a location or in an environment that include or are modified to include MLS functionality are devices that may be amended by hardware or software to expand their original functionality to participate in multi-link sensing, for example as an MLS initiator, an MLS responder, and/or a general MLS environment/location sensor, and have communication capability to communicate MLS data back to another device for processing or action. An example of a device determined by an MLS device, such as MLS device 250, to be used by it as an MLS participating device is MLS device 250 utilizing WLAN AP 112 and/or WLAN AP 112's wireless transmissions to generate an environmental signature/fingerprint, e.g., via the RF produced at a location by WLAN AP 112 or by types and patterns of data produced by WLAN AP 112 in the environment or UE 118, 218 when it enters the environment. It will also be understood that any device observing UE 118, 218 or the user of UE 118, 218 when one or both enter the location or RF/Physical environment. “Observing” can be via any electromagnetic sensors, pressure sensors, presence sensors, thermal sensors, user's gait sensors, etc. such as but not limited to image cameras, video cameras, LiDAR sensors, sonar sensors, infrared sensors, proximity sensor devices, etc., as further disclosed herein.

In the embodiment of system 240, devices 270-276 sense the RF and/or physical environment. System 240 shows UE 218 being symbolically “sensed” by device 272 via its line 3, by device 274 via its line 2, and by device 276 via its line 2. Devices 272, 274, and 276 communicate 260, 262, and 264, respectively, this information to MLS device 250. In an embodiment, if the data is RF data, then that data, or data associated with it, is stored in RF fingerprint 224. In an embodiment, if the data is physical data then it, or data associated with it, is stored in physical FP 226. Alternatively, RF data and physical data may be stored together. In another exemplary alternative 3GGP sensing data and non-3GPP sensing data may be stored separately or together.

In the example of system 240, processor 212 and/or MLS function 202 execute sense instructions 222 and compare new data stored in RF fingerprint 224 and physical FP 226 with historic data in surroundings FP 224 to determine if the sensed data from device 272, 274, and 276 relates to data in surroundings FP 225 that indicates the presence of UE 218 and/or its user. If it is determined that UE 218 and/or its user are present and in RF communication proximity to WLAN AP 112, MLS function 202 sends a message to MLS transceiver 256 via MLS interface 203, which triggers MLS transceiver 256 to communicate, via an MLS signal 280. UE 218 then processes data derived from MLS signal 280, which instructs UE 218 to switch WLAN functionality from an OFF state to and ON state, thereby enabling the off-load of data from the wireless network 103 to access network 101.

In an embodiment, MLS device 250 is both the MLS initiator and MLS responder. In another embodiment MLS device 250 is the MLS initiators and one or more of the other devices 270-276 and UE 118, 218 are MLS responders. In another embodiment UE 118, 218 is the MLS initiator and one or more of devices 270-276 and MLS device 250 are MLS responders. In another embodiment UE 118, 218 is both the MLS initiator and the MLS responder. In another embodiment one or more of MLS device 250 and devices 270-276 transmit (e.g., continuously, periodically, or randomly) one or more MLS signals that may be sensed by UE 118, 218 upon arrival at location in wireless proximity to MLS devices 250, 207-276 and/or WLAN AP 112.

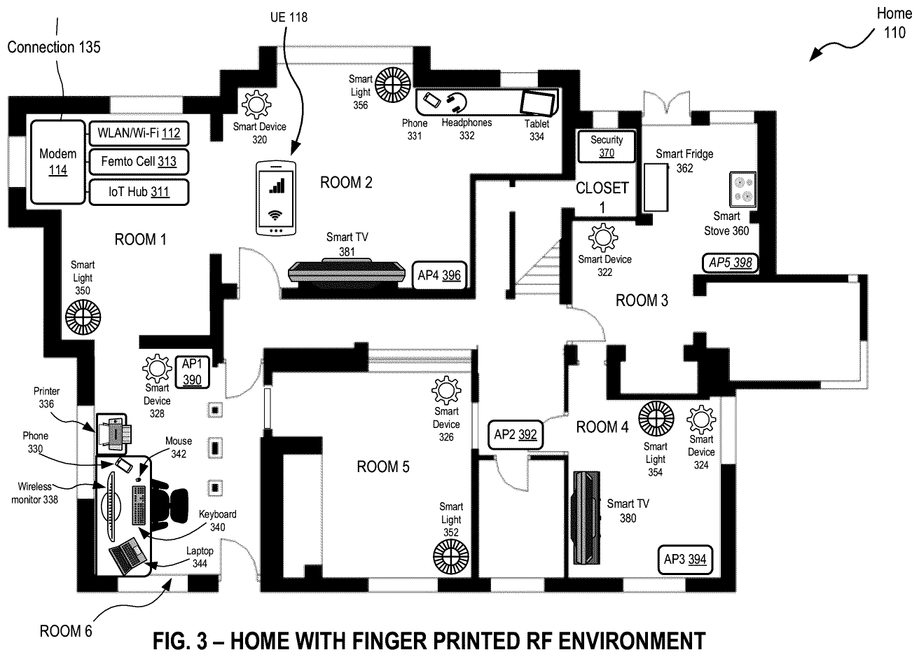

In alternative embodiments, devices 270-276 may be included in an environment similar to system 200 such that they sense the environment to determine the presence of UE 118 and communicate data and/or signaling to UE 118, 218 directly, instead of devices 270-276 communication with MLS device 250. In such embodiments, devices 270-276 may be both MLS initiators and MLS responders, may be MLS initiators and one or more of the other devices 270-276 and UE 118, 218 are MLS responders, or UE 118, 218 is the MLS initiator and one or more of devices 270-276 are MLS responders. Other variation would be understood by the skilled artisan. FIG. 3 shows a floor plan of a house, house 110 with RF producing elements and physical features, each of which may be utilized by the multi-link sensing systems and methods described herein.

House 110 includes various devices, access points (APs), RF signals generated by those devices and APs, and physical features which may be utilized by multi-link sensing functionality 202 to implement WLAN offload of data from a 3GPP network to a non-3GPP network when WLAN functionality 150, 204 is initially disabled at the UE 118.

In room 1, which may be, for example, an entry way, drop cable 135 is shown connecting modem 114 to off-load access network 101. Modem 114 is also in communication with WLAN AP 112, one example of which is a Wi-Fi AP. Room 1 also includes an in-house 3GPP defined wireless device, such as a femto cell 313, and an IoT Hub 311 communicatively coupled to modem 114 and/or WLAN AP 112. WLAN AP 112, femto cell 313, and IoT Hub 311 provide wireless connections, directly or indirectly, to devices within house 110. For example, IoT Hub 311 may provide wireless connectivity to smart lights and smart devices, WLAN AP 112 may provide wireless connectivity to smart TVs, phones, tablets, security systems, laptops, smart kitchen devices, etc., and femto cell 313 may provide connectivity to phones, tablets, and computers. Room 1 also includes a smart light 350.

Room 2, which may be a living room, includes UE 118, smart device 320, a smart light 356, a phone 331, headphones 332, a tablet 334, a smart TV 381 and an AP4 396. Closet 1 includes a security system 370, which may be connected to security devices arranged around house 110.

Room 3, which may be a kitchen, includes a smart refrigerator 362, a smart stove 360, a smart device 322 and an AP5 398.

Room 4, which may be a den, is shown with a smart light 354, a smart device 324, a smart TV 380, an AP3 394 with AP2 392 in the adjacent hallway.

Room 5, which may be a dining room, includes a smart device 326 and a smart light 352.

Room 6, which may be an in-home office, includes numerous office equipment including a laptop 344, a keyboard 340, a mouse 342, a wireless monitor 338, a phone 330, a printer 336, a smart device 328, and an AP1 390.

Each room may also include furniture, decorations, wall colors, ceiling fixtures, etc. befitting of the rooms use, each of which, alone or in combination, may be used by non-3GPP sensors 214 to identify the room and therefore its location and proximity to a WLAN AP, such as WLAN AP 112 or one of its associated mesh APs 390-398, which can be used by MLS functionality 202 to change a WLAN functionality 204, 150 from an “OFF” state to an “ON” state.

In some aspects, the RF environmental signature includes information associated with a topographical/physical arrangement of substantially stationary objects in the RF environment. For example, the RF environmental signature may include information associated with the arrangement of IoT devices, IoT Hubs, Wi-Fi Access Points (APs), Wi-Fi Stations (STAs), and wireless mesh networks in the RF environment.

In some cases, the systems and methods involve receiving, at a wireless receiver of a WLAN AP, MLS data, wherein the MLS data is one or both of a wireless sensing signal(s) and a wireless sensing data. The wireless receiver of the WLAN AP may be configured to receive MLS data from various sources in the RF environment, including but not limited to IoT devices, IoT Hubs, Wi-Fi APs, Wi-Fi STAs, wireless mesh networks, smart devices, smart kitchen appliances, computers, smart TVs, etc. The received MLS data can be processed to determine RF environmental signature, which can be used to identify the UE 118 location and proximity to WLAN AP 112 and there for cause MLS functionality 202 to enable the WLAN functionality 150, 204 on UE 118.

In some cases, the method involves transmitting an AP-to-UE signal to UE 118. This signal can be utilized by UE 118 to initiate the enablement of WLAN functionality 150, 204 on UE 118. For example, in room 2, which may be a living room, UE 118 is present along with smart device 320, smart light 356, a phone 331, headphones 332, a tablet 334, a smart TV 381 and an AP4 396. The AP4 396 can transmit an AP-to-UE signal to the UE 118, which can be leveraged to enable WLAN functionality 150, 204 on the UE 118.

In some aspects, the systems and methods involve receiving the one or both of a wireless sensing signal(s) and a wireless sensing data at a wireless receiver of the AP does not include receiving wireless sensing signal(s) and wireless sensing data from the UE. This can be achieved by utilizing the various devices and APs located within the house 110 to receive wireless sensing signal(s) and wireless sensing data, without requiring the UE 118 to transmit these signals and data.

In some cases, the systems and methods involve UE 118 recognizing the signatures of one or more devices, alone or in combination, which can produce a type or RF signature. These signals can be utilized by UE 118 to enable the WLAN functionality on the UE. For example, in room 2, which may be a living room, UE 118 is present along with smart device 320, smart light 356, a phone 331, headphones 332, a tablet 334, a smart TV 381 and an AP4 396. Unique signals or patterns of signals from these devices, lone or in combination, result in one or more environmental signatures identifiable by MLS functionality 202 to determine UE 118 is at a location with AP4 396 access to off-load access network 101 via mesh networking with WLAN AP 112. A similar process may be used in each room 1-6, in outdoor locations, offices, such as office building 109, etc.

In some aspects, the AP-to-UE signal to the UE is initiated by a UE-to-AP MLS signal. This can be achieved by the UE transmitting an MLS initiator signal to the AP, which then responds by transmitting the AP-to-UE responder signal to the UE. This can facilitate a two-way communication between the UE and the AP, allowing for more efficient and accurate determination of the UE's location and proximity to the AP. In this case the UE is the MLS initiator, and the AP is the MLS responder. It will be understood that other devices may be the MLS responder and the AP as the MLS responder is only one possibility. For example, the MLS responder may be one or more of modem 114 with MLS responder wireless functionality, the femto cell 313, IoT Hub 311, phone 330-331, tablet 334, smart device 320-328, laptop 344, etc.

In some aspects, a plurality of devices forms an MLS group which generate MLS data having improved resolution. This can be achieved by coordinating the sensing activities of multiple devices within the MLS group, allowing for more accurate and detailed sensing of the RF environment. The MLS group can include any number of devices and can include devices of different types and capabilities. For example, the MLS group can include a combination of IoT devices, WLAN APs, 3GPP devices, and other suitable devices.

In some embodiments, the present MLS systems and methods may leverage an intrusion detection process as disclosed in use case 5.1 of “3GPP TR 22.837 V19.2.1 (2024 February): 3rd Generation Partnership Project; Technical Specification Group TSG SA; Feasibility Study on Integrated Sensing and Communication (Release 19),” modified to implement the present systems and methods to off-load data traffic to a non-3GPP access network. That is, instead of using the multi-link sensing devices and processes for intrusion detection we use them for enabling WLAN offload to network 101 when WLAN is initially disabled. For example, the MLS process may detect an intrusion in the house 110 by analyzing the data from the non-3GPP sensors and 3GPP sensors in house 110 and/or at non-3GPP sensors 207 and 3GPP sensors 214 on UE 118. Instead of simply detecting an intruder, advanced MLS processes would identify a specific person or presence of a specific UE, i.e., the user of UE 118 or UE 118. Based on the advanced detection processes, systems and methods may trigger an WLAN enablement process.

A wirelessly enabled smart home is one obvious scenario where indoor/local-area sensing can be leveraged to enhance people's lives. Nowadays, various UEs, e.g. wearable devices, sensors, smart phones, and customer premise equipment (CPEs), etc. are deployed in a user's home, one example of which is house 110. To create a more comfortable and convenient indoor experience, many devices are connected via wireless signals to enable today's smart homes. In addition to their intended communication purposes, wireless signals can also be utilized for sensing, for example, to monitor the home environment. In addition, UEs are enabled with sensors that can generate data used to identify the RF and physical surroundings.

To enable user presence detection in a smart home scenario, wireless sensing take into account how wireless signals are affected by stationary objects and surfaces and the movement of people and things in the wireless environment. Wireless signal may interact with the stationary objects and surfaces to be used to generate a substantially three-dimensional map of a space. The movement of people and things in the wireless environment can be processed to represent movement in the substantially three-dimensional map of the space and even used to identify specific people and/or objects. By analysing and collecting sensing information, such as Doppler frequency shift, amplitude change, and phase change, the behaviour and identity of object or people may be determined.

A user of UE 118 may setup an MLS device in the how to provide MLS functionality for house 110. For example, the user of UE 118 sets up a device in each room at home, which support sensing functionalities. One reason for setting this up may be to ensure, when UE 118 is at home, data traffic is off-loaded from network 103 to network 101 due to, for example, one or more of network 101's low latency, throughput, security, advanced features, cost savings, etc.

In room 2, the living room, an MLS device is activated to perform the sensing operations. While RF signals provide communication services at home, the signal and reflected signals may also be received and processed at one or more MLS sensing devices, for example, APs 1-5 390-398, WLAN AP 112, and MLS enabled model 114, a dedicated MLS device (not shown), to generate sensing information. The one or more MLS sensing devices may then report the sensing information to, for example, an MLS cloud processing system (not shown), an MLS enabled modem 114, or a dedicated MLS device for further MLS processing. MLS processing may then determine one or more differences between the radio frequency signals transmitted by the MLS transmitting device and the received reflected signals, identifying the presence of UE 118 or the user of UE 118. The system may then transmit a signal to UE 118 to enable WLAN functionality 150, 204 on UE 118.

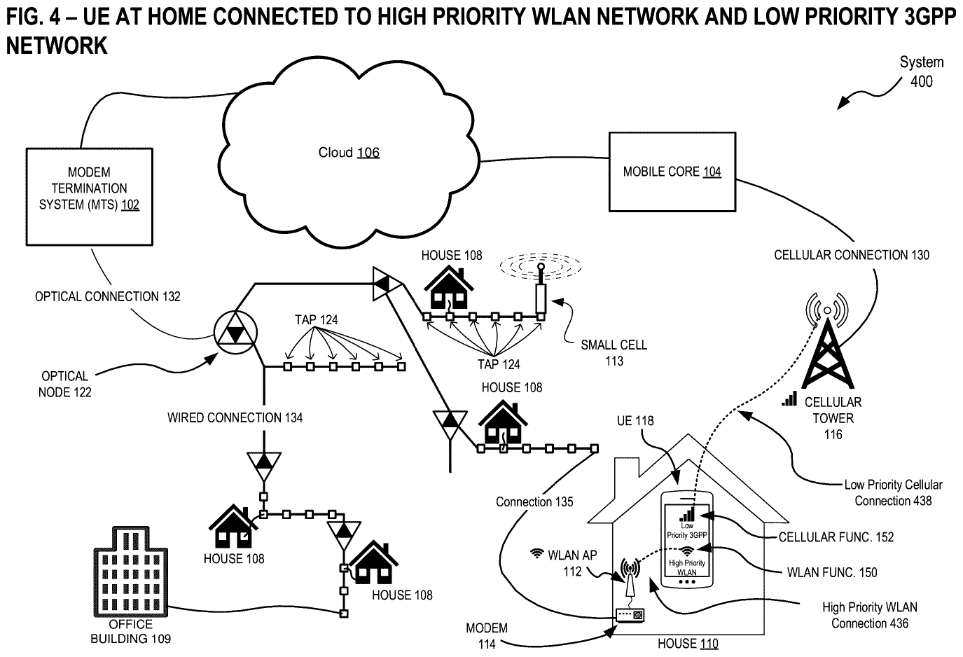

FIG. 4 shows a system 400, which is similar to systems 100 and 200, with a difference being UE 118 is located at house 110 after having WLAN functionality 150, 204 turned on via multi-link sensing functionality 202. In the embodiment of system 400, the WLAN connection to network 101 is a high priority WLAN connection 436 and the cellular connection to network 103 is a low priority cellular connection 438.

System 400 ensures seamless connectivity and efficient data offloading between the WLAN AP 112 enabled network 101 and 3GPP wireless network 103. For example, voice data may be dedicated to network 103 via low priority cellular connection 438 while all other data is dedicated to the WLAN AP 112 connection to network 101. Alternatively, voice data may be dedicated to network 103 via low priority cellular connection 438 while data requiring, for example, low latency, high throughput, or other network 101 specific beneficial aspects are dedicated to the WLAN AP 112 connection to network 101.

In some aspects, the method may further comprise migrating one or more data sessions from the 3GPP network to the off-load non-3GPP network after the WLAN connection to the off-load non-3GPP network is enabled. This can be achieved by enabling the WLAN functionality at the UE 118, connecting the UE 118 to the non-3GPP network via the WLAN, transferring the data sessions from the 3GPP network to the non-3GPP network, and prioritizing the WLAN AP 112 enabled network 101 connection.

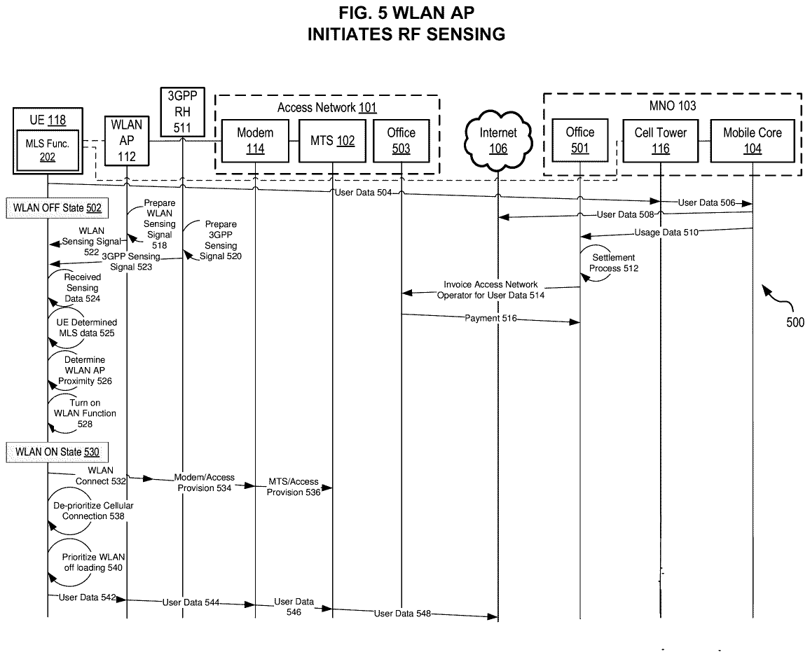

FIG. 5 shows a sequence diagram 500, illustrating the WLASN AP initiated process of multi-link sensing assisted WLAN offload to network 101.

The sequence begins in a situation similar to that shown in system 100 of FIG. 1 with UE 118 at location 2. In this situation, WLAN functionality 150 is disabled but the UE 118 is within wireless communication range of WLAN AP 112. The UE 118 is also within a known environment where MLS functionality can enable WLAN functionality 150, 204 for network 101 offloading due to location 2 being stored in surroundings FP 225 in memory 210 as on known location with WLAN access to off-load access network 101.

The sequence starts with user data 504 being transmitted from UE 118 to cellular tower 116. The mobile network operator (MNO) network 103 receives user data 506 from the cellular tower 116 at mobile core 104, which sends it as data 508 to internet 106. Usage data 510 is sent to MNO office 501 where a settlement process 512 determines a financial settlement or invoice which is sent 514 to network 101 office 503. Network 101 operator responds to the invoice by making a payment 516 to the MNO office 501. This is one simplified representation of an MVNO relationship between the operator of network 101 and the MNO operator of network 103. The operator of network 101 would like to limit the about of data sent over MVNO partner's network 103, but when the WLAN functionality is disabled on UE 118 this is hindered. As such the following method is implemented.

Next, the sequence shows the user equipment (UE) 118 starting in a WLAN OFF state 502. The WLAN AP 112 prepares optional sensing signal 518 and a 3GPP Radio Head (RH) 511 prepares optional sensing signal 520. Examples of 3GPP RHs 511 include but are not limited to femto cells 313, a nanocell, a picocell, a microcell, a small cell, an eNodeB, a gNodeB, a macocell/cell tower, an xNodeB (one of the next generations of NodeBs), or any 3GPP defined multi-link sensing (initiator and/or responder). UE 118 receives WLAN sensing signal 522 from WLAN AP 112 and a 3GPP sensing signal 523 from 3GPP RH 511. UE 118 then processes received sensing data 524 from the WLAN AP 112 and the 3GPP RH 511 and optionally determines and processes it's on non-3GPP MLS data 525. Based on this data, the UE 118 determines its wireless communication proximity to WLAN AP 112 in step 526 and subsequently turns on the WLAN functionality 150, 204 in step 528.

Once the WLAN functionality is enabled, the UE 118 transitions to the WLAN ON state 530. The UE 118 connects to the WLAN 532, connects to the modem/access network 534, and connects to the MTS/access network 536. The UE 118 then optionally de-prioritizes the cellular connection 538 and optionally prioritizes WLAN offload to network 101 in step 540. User data is then transmitted through the WLAN AP 112 in step 542, modem 114 in step 544, to MTS 102 in step 546, to the internet 106 in step 548. Thus, offloading traffic to network 101 from network 103 by enabling WLAN functionality 150, 204 when it is initially disabled. This can reduce congestion on the licensed wireless spectrum, reduces cost for network 101 in a MVNO relationship with the MNO operator of network 103, provides network 101 advanced features to users of the network, etc.

The MLS functionality facilitates the offloading of user data sessions from the 3GPP wireless network, which incurs an expense to the access network 101 operator, to the access network 101 via a WLAN connect that is initially disabled on the UE 118. This process ensures seamless connectivity and efficient data offloading between the WLAN enabled network 101 and 3GPP wireless network 103. In addition, this process can reduce congestion on the licensed wireless spectrum for more efficient spectrum utilization and can provide network 101 advanced features to its paying customers.

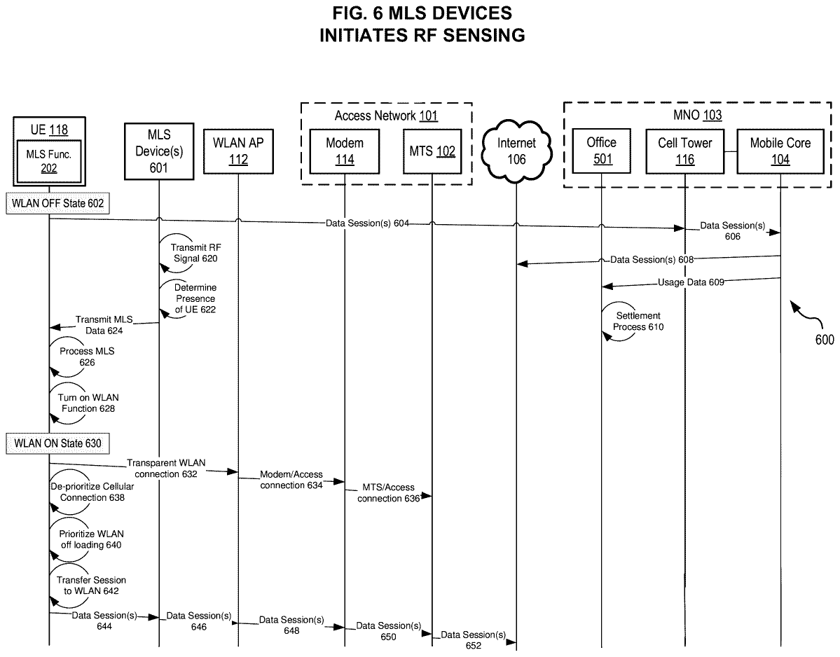

Referring now to FIG. 6, a sequence diagram 600 is depicted, illustrating a process of Multi-Link Sensing (MLS) assisted WLAN offload from a 3GPP network 103 to a non-3GPP network 101. This process is initiated by MLS device(s) 601.

MLS device(s) 601 may be an existing device implemented with MLS functionality (e.g., tablet 334, laptop 344, smart device 324, WLAN AP 112, etc.) or may be a dedicated MLS device (e.g. smart device 320), or a device that is determined to be an MLS device by MLS functionality 202 utilizing its normal functionality (e.g., WLAN AP 12, IoT Hub 311, femto cell 313, smart TV 381, security system 370, etc.), or device enhanced with MLS functionality (e.g., modem 114 or WLAN AP 112).

The sequence diagram 600 is similar to sequence diagram 500 with a few important differences. First, diagram 600 replaces the 3GPP radio head 511 with multi-link sensing device(s) 601. Second, diagram 600 does not show the network 101 office 503 and its associated steps within the sequence diagram, which are assumed to exist but not shown for sake of simplicity and to increase clarity. Finally, instead of user data transmitted from UE 118 and migrated from network 103 to network 101 as in FIG. 5, FIG. 6 shows data sessions being migrated from network 103 to network 101. It will be understood that the process, devices, and steps described in sequence diagram 500 and 600 may be mixed or blended such that data sessions may replace user data in diagram 500 and vice versa for diagram 600, without departing from the scope herein.

Sequence diagram 600 begins with the User Equipment (UE) 118 in a WLAN OFF state 602 such that UE 118 only has access to network 103, similar to sequence diagram 500. UE 118 has a data session 604 established between itself and cellular tower 116, data session 606 between tower 116 and mobile core 104, with the session 608 established between mobile core 104 and internet 106. Any data sent from UE 118 via this data session is tracked and placed in a usage report and sent 609 to office 501 for settlement processing 610, which will be invoiced to the operator of network 101, in a process similar to that shown in diagram 500 of FIG. 5 in steps 514-516.

MLS Device(s) 601 transmits, either continuously, periodically, randomly, or event driven, an RF signal 620 to determine the presence of the UE 118 in step 622. Upon determining the presence of UE 118, the MLS Device(s) 601 transmits MLS data 624 to UE 118. UE 118 processes the MLS data 626 and subsequently turns on the WLAN functionality 628, transitioning to the WLAN ON state 630.

In the WLAN ON state, a transparent WLAN connection 632 occurs, followed by modem/access connection 634 and MTS/access connection 636. UE 118 then optionally de-prioritizes the cellular connection 638 and optionally prioritizes WLAN offloading 640. The data session is transferred to the WLAN 642, and data sessions 644, 646, 648, 650, and 652 are established. This sequence ensures that the UE can offload data sessions from the 3GPP network to the off-load access network 101 via the WLAN, optimizing network usage, improving data throughput for the user, providing access to network 101 advanced features, and reducing cost for the operator of network 101.

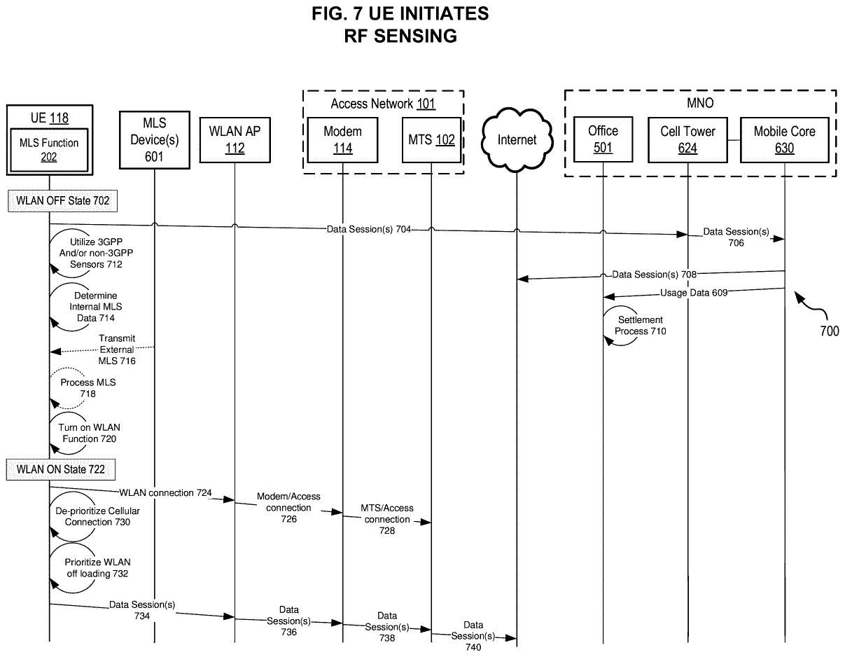

FIG. 7 shows a sequence diagram 700 illustrating a process of Multi-Link Sensing (MLS) assisted WLAN offload from a 3GPP network 103 to a non-3GPP network 101, which is initiated by the User Equipment (UE) 118.

The sequence begins with the UE 118 in a WLAN OFF state 702, indicating that the UE 118 initially only has access to the 3GPP network 103, similar to sequence diagrams 500 and 600. The UE 118 has a data session 704 established between itself and a cellular tower 116, a data session 706 between the cellular tower 116 and a mobile core 104, and a data session 708 established between the mobile core 104 and the internet 106. Any data sent from the UE 118 via this data session series is tracked and placed in a usage report and sent 709 to office 501 for settlement processing 710. This process will result in an invoice being sent to the operator of network 101, in a process similar to that shown in diagram 500 of FIG. 5 in steps 514-516, not shown here for sake of clarity.

UE 118 initiates the process by utilizing one or both of 3GPP and non-3GPP sensors 712. These sensors may include, but are not limited to, cameras, LIDAR, microphones, GPS, 3GPP radios, non-3GPP radios, etc., as described above, configured on UE 118 to capture data associated with UE 118's immediate surroundings. This data is then processed via a determine internal MLS data 714 process to determine if the immediate surroundings are the same as one stored in memory, which is determined, for example, by comparing the surroundings FP 225 to fingerprint 224, 226 stored in memory 210. Optionally or additionally, MLS Device(s) 601 may transmit external MLS data 716 which are received by the UE 118 at one or more non-AP antennas. Examples of non-AP antennas include but are not limited to 3GPP antenna, a Bluetooth antenna, an IoT antenna, Near-Field Communication (NFC) antenna, or any other antenna that utilizes unlicensed, partially licensed spectrum (e.g., CBRS), or licensed spectrum.

The UE 118 processes the MLS data 718 to determine if the RF and/or physical fingerprint of the captured data is substantially the same as an RF and/or physical fingerprint associated with a location of WLAN AP 112 and network 101, stored in memory in surroundings fingerprint (FP) 225. If the UE 118 determines that the immediate location or the RF fingerprint, is one associated with WLAN AP 112 and network 101, then the UE 118 turns on the WLAN functionality 720, transitioning the UE to a WLAN ON state 722. Turning on WLAN functionality may be MLS functionality 202 processing sensor 207, 214 data, storing the results in fingerprints 224, 226, comparing the results to surroundings FP 225, then transmitting a signal via MLS interface 203 to WLAN ON/OFF function 205 to turn on WLAN functionality 204.

Once the WLAN functionality is enabled, the WLAN connection 724 is established, and modem/access connection 726 and MTS/access connection 728 are established. UE 118 may optionally de-prioritize the cellular connection 730 and optionally prioritize WLAN offloading 732. The UE then establishes data sessions 734 with WLAN, data sessions 736 between WLAN AP 112 and the modem 114, data sessions 738 between modem 114 and MTS 102, finally connecting the data sessions 740 between MTS 102 and internet 106.

The sequence ensures that the UE can offload data sessions from the 3GPP network to the non-3GPP network via the WLAN, optimizing network usage, improving data throughput for the user, providing access to network 101 advanced features, and reducing cost for the operator of network 101.

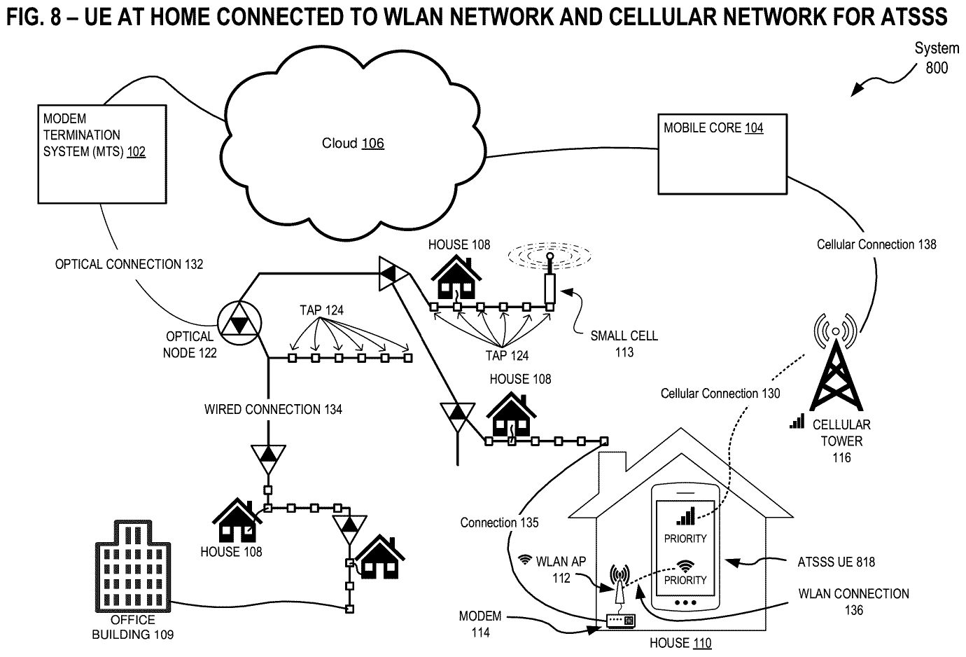

FIG. 8 shows a system 800 for a user equipment (UE) at home connected to a WLAN network and a cellular network leveraging 3GPP's Access Traffic Steering, Switching and Splitting (ATSSS) functionality or CableLabs' Adaptive Route Control (ARC) mobile functionality. ATSSS or ARC are not possible if WLAN functionality 150, 204 is disabled on the UE.

System 800 is similar to systems 100 and 400, with a difference being that UE 118 is replaced with ATSSS enabled UE 818. UE 818 does not deprioritize the connection 138, but instead utilizes both the connection 130 and the WLAN connection 136 plus network 101 connection for ATSSS functionality, as defined by 3GPP. This requires WLAN functionality on UE 818 to be enabled, otherwise the benefits of ATSSS cannot be leveraged.

In some aspects, the ATSSS enabled UE 818 may utilize both the cellular connection 130 and the WLAN connection 136 for ATSSS functionality. This can provide seamless and efficient data offloading between the WLAN enabled network 101 and 3GPP wireless network 103. For example, voice data may be dedicated to network 103 via cellular connection 130 while data requiring, for example, low latency, high throughput, or other aspects may be switched, split, and or steered between WLAN AP 112 enabled network 101 and network 103.

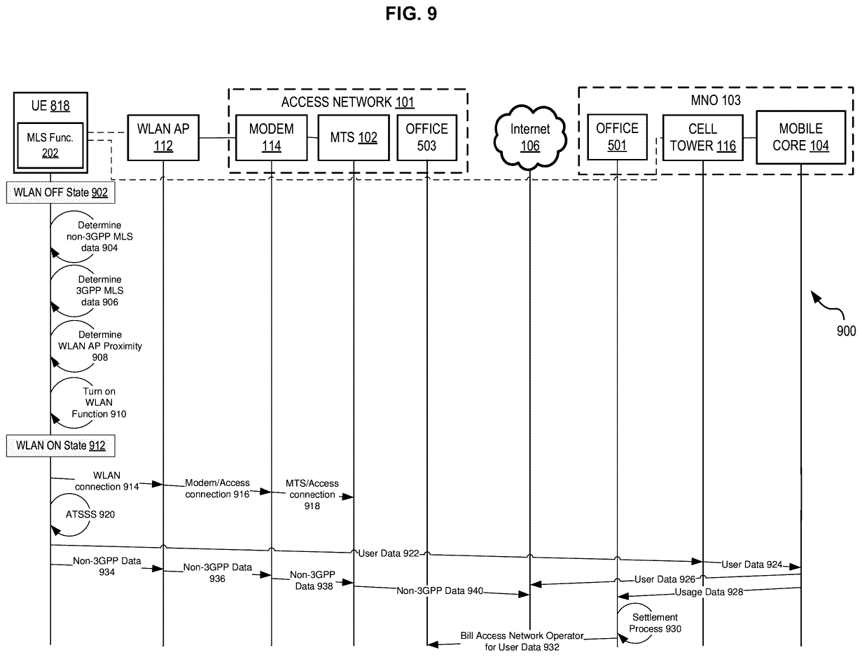

FIG. 9 shows a sequence diagram 900 for enabling WLAN functionality on UE 118, when it is initially disabled, such that ATSSS operations may be utilized. Sequence diagram 900 is shown being initiated by UE 118, although it may be initiated by any means disclosed herein.

Sequence diagram 900 begins with the User Equipment (UE) 818 in a WLAN OFF state 902. The Multi-Link Sensing (MLS) functionality 202 within UE 118 collects, via one or both of non-3GPP MLS data 904 and 3GPP MLS data 906, data associated with the UE's immediate surroundings. UE 818 then determines it is within WLAN AP communication proximity 908 and subsequently turns on the WLAN functionality 910, transitioning the UE 818 to a WLAN ON state 912. As stated above this process may alternatively be initiated by the WLAN AP, a 3GPP RH, an MLS device, or any other device or process known to the skilled artisan.

Once in the WLAN ON state 912, the WLAN connection 914, modem/access connection 916, and the MTS/access connection 918 are established. The Access Traffic Steering, Switching, and Splitting (ATSSS) 920 process is then executed, resulting in user data being steered, switched, and/or split between network 101 and 103. In the example of sequence diagram 900, user data is transmitted from the UE to the wireless network 103 via user data 922 to cellular tower 116, user data 924 to mobile core, and user data 926 to internet 106.

Non-3GPP data is sent through network 101 via user data 934 sent from the UE to WLAN AP 112, which is then forwarded as non-3GPP data 936 to modem 114, non-3GPP data 938 to MTS 102 and as non-3GPP data 940 to internet 106.

In an MVNO embodiment, optionally usage data 928 is collected and sent to the settlement process 930, which then generates an invoice for the access network 101 operator and sent 932 to office 503. This sequence diagram illustrates the process of multi-link sensing assisted WLAN offload to network 101, which is initiated by one or more of WLAN AP 112, a 3GPP radio head 511, and UE 118's MLS Functionality 202.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for controlling a user equipment (UE) utilizing multi-link sensing (MLS) to off-load one or more data sessions from a 3GPP network to a non-3GPP network via a Wireless Local Area Networks (WLAN) when a WLAN functionality is initially disabled at the UE, comprising the steps of:
receiving, at one or more MLS sensors of the UE, MLS information associated with one or both of a radio frequency (RF) environment and a physical environment;
processing, by a computational processor, the received MLS information to determine an environmental signature;
comparing the determined environmental signature against one or more previously generated environmental signatures stored in memory, the one or more previously generated environmental signatures stored in memory associated with one or more WLANs providing wireless access to the non-3GPP network; and
based on a positive result from the comparing step, enabling the WLAN functionality at the UE to facilitate off-loading of at least one data session from the 3GPP network to the non-3GPP network.

2. The method of claim 1, wherein the determined environmental signature includes information associated with a topographical arrangement of substantially stationary objects in one or both of the RF environment and the physical environment.

3. The method of claim 1, wherein the one or more previously generated environmental signatures stored in memory contains data associated with one or more physical objects and radio frequency sources utilized to uniquely identify each of the one or more previously generated environmental signatures.

4. The method of claim 1, wherein the one or more previously generated environmental signatures stored in memory includes information related to a UE-to-WLAN connection associated with one or more known WLAN Access Points (APs) for off-loading of data from the 3GPP network to the non-3GPP access network via the WLAN.

5. The method of claim 1, wherein the determined environmental signature includes information associated with one or more of IoT device, an IoT Hub, a Wi-Fi Access Point (AP), a Wi-Fi Station (STA), a Wi-Fi mesh AP, a radio head as defined by a 3GPP standard, a LoRa WAN AP, a Helium AP, a Bluetooth device, a Connectivity Standards Alliance (CSA) IoT device, a Matter IoT device, a Near Field Communication (NFC) device, and a Citizens Broadband Radio Service (CBRS) device.

6. The method of claim 1, further comprising executing instruction to initiate migrating one or more data sessions from the 3GPP network to the non-3GPP network.

7. The method of claim 1, wherein the MLS information associated with one or both of the radio frequency (RF) environment and the physical environment are generated by one or both of 3GPP sensors and non-3GPP sensors.

8. The method of claim 7, wherein the non-3GPP sensors are selected from the group consisting of an image camera, a video camera, a LiDAR sensor, a sonar sensor, an infrared sensor, a satellite navigation sensor, a Proximity sensor device, a New Radio Proximity Services (NR ProSe) device, an Ultra-wideband (UWB) device, an IEEE 802.11 device, and a Wi-Fi sensing device.

9. The method of claim 1, further comprising receiving one or more non-3GPP sensing data associated with one or both of a radio frequency (RF) environment and a physical environment.

10. The method of claim 1, wherein the non-3GPP network is one or more of a DOCSIS network, an optical network, a Digital Subscriber Line (DSL) network, a Very Low Earth Orbit (VLEO) Satellite network, a Low Earth Orbit (LEO) Satellite network, a Medium Earth Orbit (MEO) Satellite network, a Geostationary Earth Orbit (GEO) Satellite network, a Citizens Broadband Radio Service (CBRS) network, a Asymmetric digital subscriber line (ADSL) network, and a converged network.

11. The method of claim 1, further comprising, based on a negative result from the comparing step, determining the UE is not in wireless proximity to the WLAN associated non-3GPP network and disabling the WLAN functionality at the UE.

12. The method of claim 1, wherein one or more of the WLAN, the UE, and a non-3GPP network modem coordinate with the non-3GPP network to migrate one or more data sessions from the 3GPP network to the non-3GPP network.

13. The method of claim 1, wherein received wireless signals associated with the MLS information are received by the UE utilizing a Directional Multi Gigabit (DMG) sensing protocol.

14. The method of claim 1, further comprising using range doppler functionality to determine the UE is within wireless communication proximity of the WLAN associated with the non-3GPP network.

15. The method of claim 1, wherein enabling the WLAN functionality at the UE is performed by a WLAN ON/OFF function which receives instructions from an MLS function via an MLS interface.

16. The method of claim 1, wherein multi-link sensing is initiated is by the UE.

17. The method of claim 1, wherein multi-link sensing is initiated is by an AP.

18. The method of claim 1, wherein multi-link sensing is initiated by a client.

19. The method of claim 1, wherein a multi-link sensing responder is a dedicated MLS device situated in the RF environment.

20. The method of claim 1, wherein the UE transmits a Physical layer Protocol Data Unit (PPDU) for use as an MLS signal.

21. A method for off-loading data traffic from a 3GPP network to an off-load access network having a Wireless Local Area Network (WLAN) interface when a WLAN functionality is initially disabled at a UE, comprising the steps of:
receiving, at a receiver, Multi Link Sensing (MLS) data, wherein the MLS data is one or more of a wireless sensing signal(s), a wireless sensing data, and physical environmental data;
processing the received MLS data to determine if the UE is in a location associated with a wireless environment having a previously prepared WLAN association to an off-load access network; and
transmitting a signal to enable the WLAN functionality on the UE.

22. The method of claim 21, wherein MLS data is generated by one or more of a 3GPP protocol, an IEEE 802.11bf protocol, Bluetooth protocol, Wi-Fi Alliance (WFA) protocol, a Wireless Broadband Alliance (WBA) protocol, a Connectivity Standards Alliance/Matter (CSA/Matter) protocol, and an IEEE 802.11 protocol.

23. The method of claim 21, wherein one or both of the wireless sensing signal(s) and the wireless sensing data is generated from one or more of a Wireless Personal Area Network (WPAN), a WLAN, and a Campus/Corporate Area Network (CAN).

24. The method of claim 21, wherein the WLAN utilizes one or more unlicensed spectra and partially licensed spectra.

25. The method of claim 21, wherein the WLAN is a network utilizing unlicensed spectrum is a 5G New-Radio Unlicensed (5G NR-U) network.
